(19) United States
(12) Patent Application Publication
(10) Pub. No.: US 2010/0270691 A1
(43) Pub. Date: Oct. 28, 2010

(54) METHOD FOR MANUFACTURING LENS ASSEMBLY

(75) Inventor: HSIN-HUNG CHUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/649,494

(22) Filed: Dec. 30, 2009

(30) Foreign Application Priority Data
Apr. 27, 2009 (CN) 200910301893.2

(51) Int. Cl. G02B 1/12

(52) U.S. Cl. 264/1.36

(57) ABSTRACT

A method for manufacturing a lens assembly includes the below steps. Firstly, a lens having an optical central portion and an annular connecting portion having a first surface is provided. Secondly, a filter comprising a glass substrate and a filter film formed thereon is provided, the glass substrate has a second surface. Thirdly, the first surface and the second surface are treated with oxygen plasma to improve a hydrophilic property thereof. Fourthly, the filter is positioned on the annular connecting portion, the first surface is in contact with the second surface, and a lens assembly comprising the lens and the filter is obtained.

### BACKGROUND

1. Technical Field

The present disclosure relates to a method for manufacturing a lens assembly and, particularly to a method for manufacturing a lens assembly including a combined lens and filter.

2. Description of Related Art

A camera module usually includes a lens module, a filter, and an image sensor. When packaging a camera module, the filter is arranged between the lens module and the image sensor to filter unwanted light. This arrangement prevents further desired miniaturization of camera modules.

What is needed, therefore, is a method for manufacturing a lens assembly to overcome the above described shortcomings

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a sectional view of a lens in accordance with an exemplary embodiment.

FIG. 2 is a top view of a mold in accordance with an exemplary embodiment.

FIG. 3 is a cross-sectional view of the mold taken along line III-III of FIG. 2.

FIG. 4 is similar to FIG. 3, but showing a molding material for forming a lens array applied on the mold.

FIG. 5 is similar to FIG. 4, but showing the lens array removed from the mold.

FIG. 6 is a sectional view of a filter according to the exemplary embodiment.

FIG. 7 is a schematic, cross-sectional view of a lens assembly according to the exemplary embodiment.

### DETAILED DESCRIPTION

Embodiments will now be described in detail below with reference to the drawings.

A method for manufacturing a lens assembly according to an embodiment includes the following steps:
providing a lens comprising an optical central portion, a peripheral portion adjoining the optical central portion, and an annular connecting portion formed on the peripheral portion, the annular connecting portion has a first surface;
providing a filter comprising a glass substrate and a filter film, the glass substrate having a third surface and a fourth surface opposite to the third surface, the filter film formed on the fourth surface;
treating the first surface and the third surface using oxygen plasma to improve a hydrophilic property thereof; and
positioning the filter on the annular connecting portion in such a manner that the first surface contacts the third surface to cause a chemical reaction between the first and third surfaces.

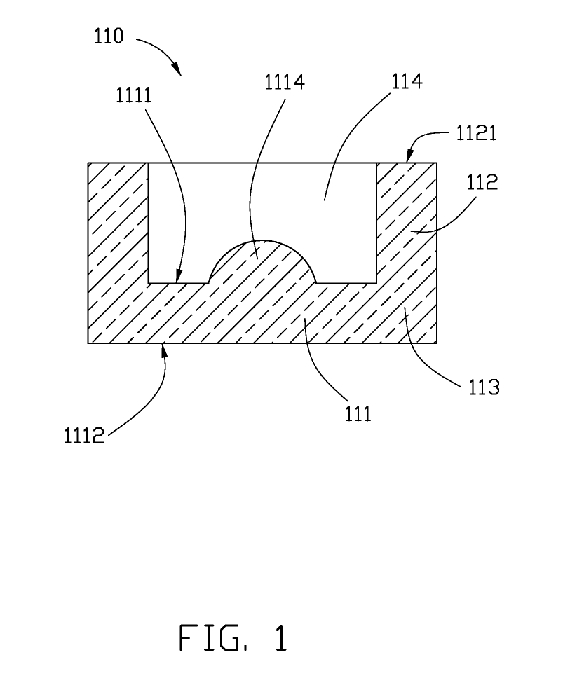

Referring to FIG. 1, a lens 110 includes an optical central portion 111, a peripheral portion 113 adjoining the optical central portion 111, and an annular connecting portion 112 formed on the peripheral portion 113. The optical central portion 111 is circular, and has a top surface 1111 and an opposite bottom surface 1112. In the present embodiment, the lens 110 is a convex lens. The optical central portion 111 defines a circular optical protrusion 1114 on the top surface 1111. A surface of the optical protrusion 1114 can be either spherical or aspheric. It can be understood that, the lens 110 also can be a concave lens. In other words, the optical center portion 111 also can define an optical recess in the top surface 1111.

The peripheral portion 113 surrounds and adjoins the optical central portion 111. The optical center portion 111 and the annular connecting portion 112 are coaxial. The annular connecting portion 112 and the optical protrusion 1114 are on the same side of the optical center portion 111. The optical center portion 111 and the annular connecting portion 112 define a space 114. An outer diameter of the annular connecting portion 112 is equal to an outer diameter of the peripheral portion 113. The annular connecting portion 112 has a first surface 1121 facing away from the peripheral portion 113.

The lens 110 can be manufactured by a following method.

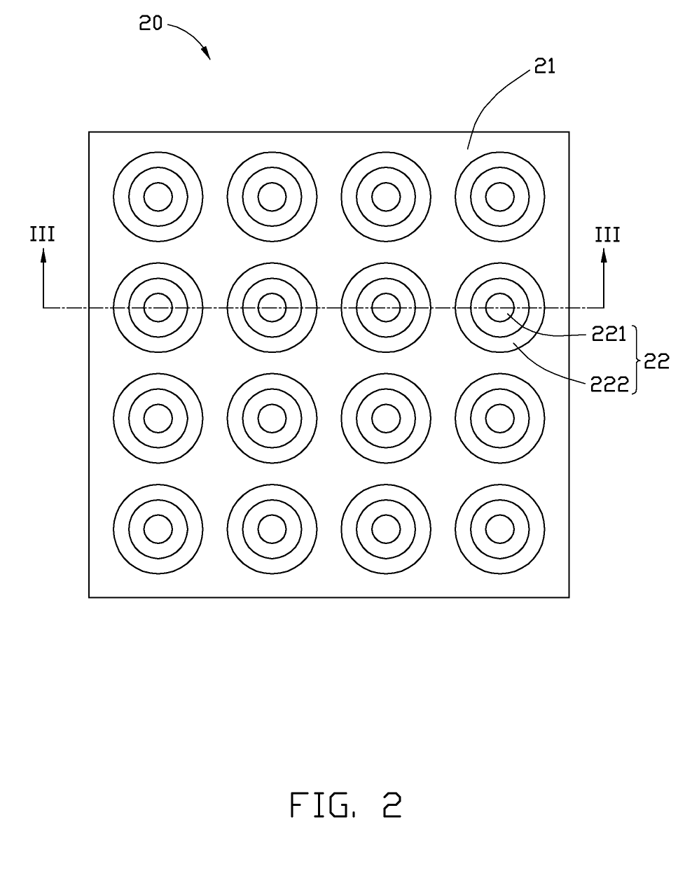

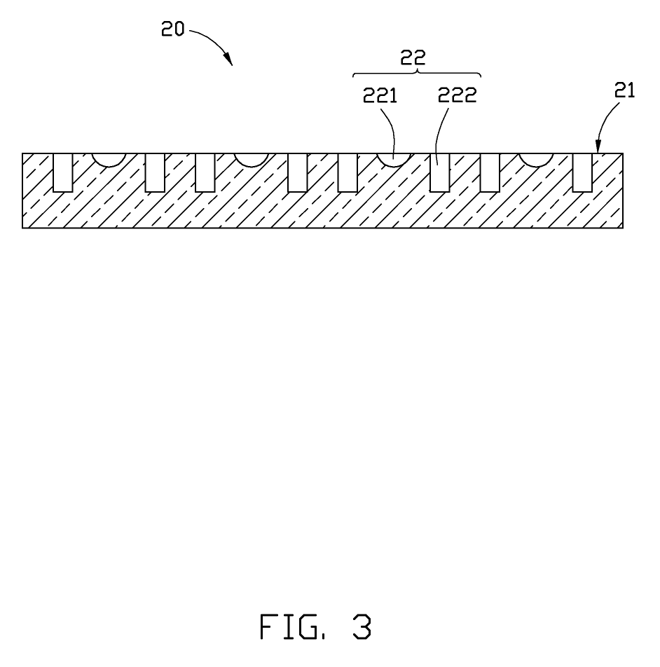

Firstly, referring to FIGS. 2 and 3, a mold 20 is provided. The mold 20 includes a molding surface 21, which defines an array of microstructure groups 22 therein. Each of the microstructure groups 22 has a structure similar to that of the lens 110. In the present embodiment, each of the microstructure groups 22 comprises a first recess 221 and a second recess 222. A shape of the first recess 221 corresponds to that of the optical center portion 111, and a shape of the second recess 222 corresponds to that of the annular connecting portion 112. When the lens 110 is concave, the first recess 221 can instead be a protrusion. A surface of the first recess 221 can be spherical or aspherical. The second recess 222 has an annular cross section. In each microstructure group 22, the second recess 222 surrounds the first recess 221, and the second recess 222 and the first recess 221 are coaxial. The material of the mold 20 can be either plastic or metal. In the present embodiment, the mold 20 is comprised of aluminum.

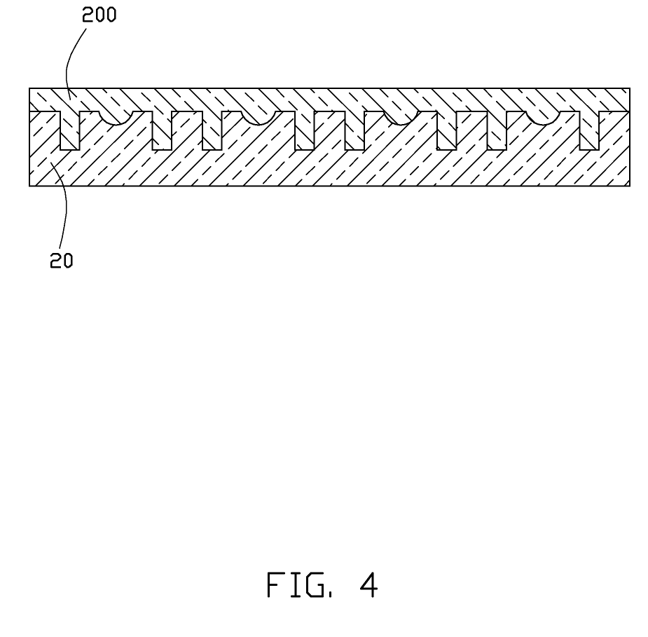

Secondly, referring to FIGS. 3 and 4, a melted polydimethylsiloxane (PDMS) material is applied on the molding surface 21 and then cured. More specifically, an excess amount of the melted PDMS is directly applied on the molding surface 21 of the mold 20. Then, a spin coating process is performed. The mold 20 is placed on a substrate (also called spin coater, or spinner), and is then rotated at a high speed in order to spread the melted PDMS by centrifugal force. The substrate continues to rotate while the melted PDMS spins off the edges of the substrate, and the melted PDMS fills the first recesses 221 and the second recesses 222 and forms a PDMS layer with a uniform thickness on the molding surface 21 about the same as the thickness of the peripheral portion 113. The effect of the liquid surface tension results in good surface uniformity, providing that the liquid PDMS has uniform thickness. The faster the spinning used, the thinner the lens array 200 will be. The thickness also depends on the viscosity of the melted PDMS. To form a lens array 200 about the thickness of 1 micrometer, the melted PDMS is typically spun at 20 to 80 Hz for 30 to 60 seconds. After the PDMS layer is formed on the molding surface 21, the melted PDMS is cured to form a lens array 200. In the present embodiment, the melted PDMS is heated to 125 Celsius degrees for about 15 minutes.

A mold release agent can be coated on the molding surface 21 prior to spinning the melted PDMS. More specifically, a container of the mold release agent, such as a siloxane liquid, and the mold 20 are placed in a sealed chamber. Under a predetermined temperature for a predetermined time, the gas volatilized by the mold release agent attaches to the molding surface 21.

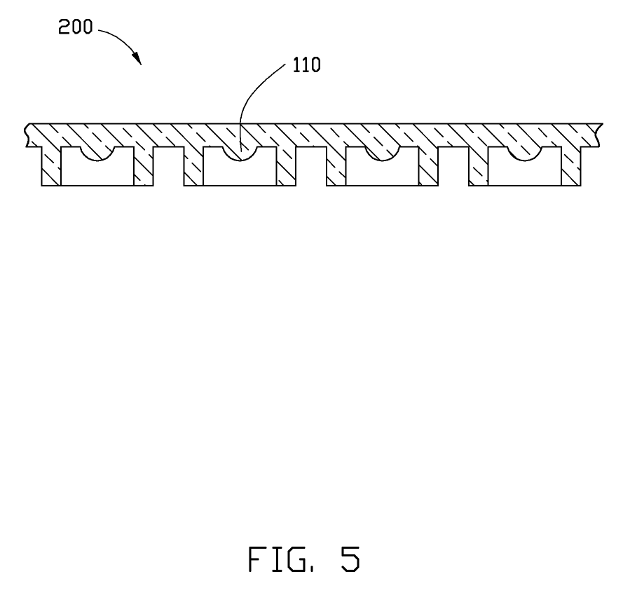

Thirdly, referring to FIGS. 4 and 5, the mold 20 is removed to obtain the lens array 200 comprising a plurality of lenses 110 is obtained.

Fourthly, referring to FIGS. 1 and 5, the lens array 200 is cut into a plurality of separate lenses 110.

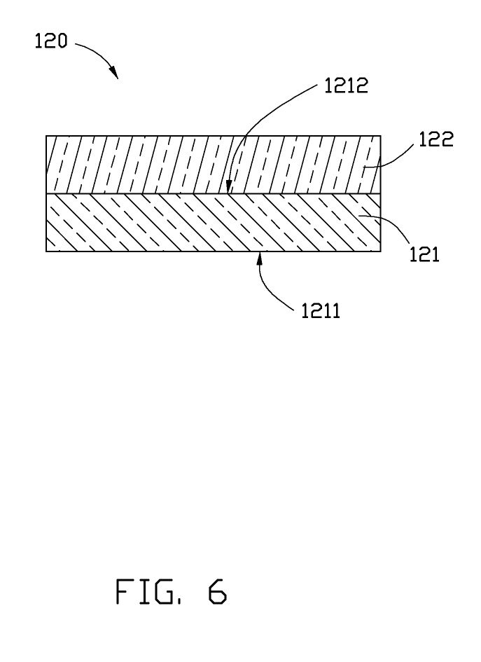

Referring to FIG. 6, a filter 120 is provided. The filter 120 comprises a glass substrate 121 and a filter film 122. The filter 120 is circular. A diameter of the filter 120 is equal to the outer diameter of the annular connecting portion 112. The glass substrate 121 has a third surface 1211 and a fourth surface 1212 at an opposite side thereof to the first surface 1211. The filter film 122 is formed on the fourth surface 1212. The glass substrate 121 consists essentially of silicon dioxide glass. The filter film 122 can be an IR-cut filter, in another embodiment the filter film 122 can be an IR-through filter film or other filter film for filtering a predetermined wavelength range. The filter film 122 can be formed by sputtering or other coating method.

The lens 110 and the filter 120 are treated with oxygen plasma to improve the hydrophilicity thereof. In the present embodiment, the lens 110 is composed of PDMS, when it is treated in the oxygen plasma, a methyl (—CH3) on the first surface 1121 is transformed into hydroxyl (—OH). As the glass substrate 121 comprising silicon dioxide, when it is treated using the oxygen plasma, the oxygen of the silicon dioxide on the third surface 1211 of the glass substrate 121 is transformed into hydroxyl (—OH). Therefore the hydrophilicity of first surface 1121 and the third surface 1211 is improved.

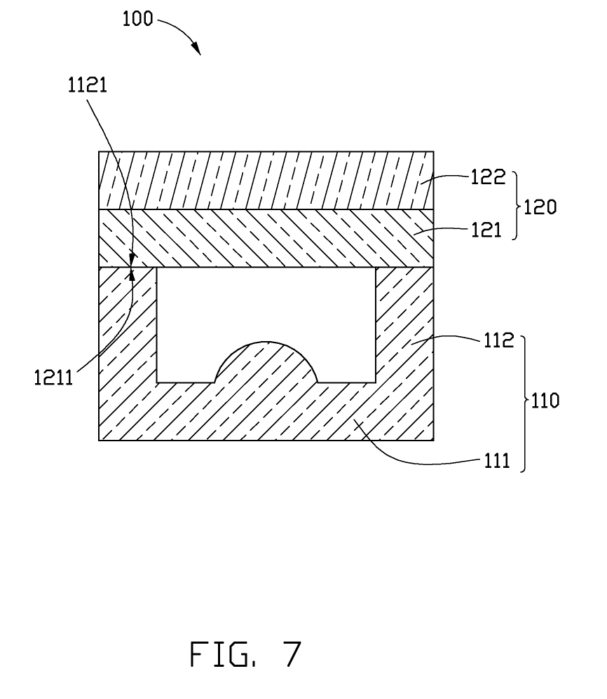

Referring to FIG. 7, the filter 120 is positioned on the annular connecting portion 112, a chemical reaction causes between the first surface 1121 and the third surface 1211 to bind the lens 110 and the filter 120 together.

When the filter 120 is positioned on the lens 110, the filter 120 and the lens 110 optically align with each other, and the first surface 1121 contacts the third surface 1211. In the present embodiment, the filter 120 and the lens 110 are kept at 80 degrees Celsius for about 10 minutes, and a chemical reaction occurs between the first surface 1121 and the third surface 123, the filter 120 and the lens 110 become interconnected forming an integrated lens assembly 100. More specifically, in the chemical reaction, a hydroxyl of the first surface 1121 and the third surface 123 react each other, each two reacting hydroxyls remove a molecule of water (H₂O), and therefore the first surface 1121 and the third surface 1211 are chemically bonded.

While certain embodiment has been described and exemplified above, various other embodiments will be apparent to those skilled in the art from the foregoing disclosure. The present disclosure is not limited to the particular embodiments described and exemplified but is capable of considerable variation and modification without departure from the scope of the appended claims.

1. A method for manufacturing a lens assembly, comprising:
providing a lens comprising an optical central portion, a peripheral portion adjoining and surrounding the optical central portion, and an annular connecting portion formed on the peripheral portion, the annular connecting portion having a first surface;
providing a filter comprising a glass substrate and a filter film, the glass substrate having a second surface and a third surface at an opposite side thereof to the second surface, the filter film being formed on the third surface;
treating the first surface and the second surface using an oxygen plasma to improve hydrophilicity thereof; and
positioning the filter on the annular connecting portion in such a manner that the first surface contacts the second surface, thereby causing a chemical reaction between the first and second surfaces, to bind the lens and the filter together.

2. The method of claim 1, wherein the glass substrate consists essentially of silicon dioxide, and the lens consists essentially of polydimethylsiloxane.

3. The method of claim 1, wherein the step of providing the lens comprising:
providing a mold comprising a molding surface, the molding surface having a plurality of microstructures defined in the molding surface;
applying a melted material on the molding surface and curing the melted material to form a lens array; and
cutting the lens array into a plurality of lens each having a structure conforming to one of the microstructures of the molding surface.

4. The method of claim 3, wherein the glass substrate consists essentially of silicon dioxide, and the lens consists essentially of polydimethylsiloxane.

5. The method of claim 3, further comprising a step of applying a mold release agent on the molding surface prior to the step of applying the melted material on the molding surface.

6. The method of claim 5, wherein the mold release agent contains a siloxane liquid.

7. The method of claim 1, wherein the step of positioning the filter on the annular connecting portion is performed at the temperature of about 80 Celsius degrees for about 10 minutes.

8. The method of claim 1, wherein the melted material is maintained at the temperature of about 125 Celsius degrees for about 15 minutes to be cured.

9. The method in claim 1, wherein the first surface faces away from the peripheral portion.

10. The method of claim 1, wherein the filter is a circular plate, an outer diameter of the annular connecting portion is equal to a diameter of the filter.

11. The method of claim 1, wherein the filter and the lens are optically aligned with each other in the step of positioning the filter on the annular connecting portion.
